(19) United States
(12) Patent Application Publication
(10) Pub. No.: US 2025/0103980 A1
(43) Pub. Date: Mar. 27, 2025

(54) System and Method for Automating Remediation

(71) Applicant: The Toronto-Dominion Bank, Toronto (CA)

(72) Inventors: Arash DELJAVAN FARSHI, Richmond Hill (CA); Adam COWIN, Kingston (CA); Arthur BYDON, Toronto (CA); Gilbert CHANG, Toronto (CA); Zheng WANG, Toronto (CA)

(73) Assignee: The Toronto-Dominion Bank, Toronto (CA)

(21) Appl. No.: 18/671,311

(22) Filed: May 22, 2024

Related U.S. Application Data
(63) Continuation-in-part of application No. 18/474,492, filed on Sep. 26, 2023.

(51) Int. Cl. G06Q 10/0631; G06Q 40/02

(52) U.S. Cl. CPC G06Q 10/06312; G06Q 40/02

(57) ABSTRACT

A system, device and method are provided for at least in part automating remediation in an enterprise system. An illustrative method includes receiving a request to perform an action, the action requiring at least one of a plurality of subsystems to be completed. The plurality of subsystems include employee and customer subsystems. The method includes transmitting an event, based on the request, to the at least one of a plurality of subsystems via an event subsystem. The method includes with an automated remediation platform: monitoring events sent from the at least one of a plurality of subsystems to the event subsystem to detect a failure; and in response to detecting the failure, generating a trigger event for consumption by the event subsystem. The method includes in response to receiving the trigger event, transmitting a remediation event for consumption by the at least one of a plurality of subsystems.

### CROSS-REFERENCE TO RELATED APPLICATION(S)

This application is a continuation-in-part (CIP) of U.S. patent application Ser. No. 18/474,492 filed on Sep. 26, 2023, the entire contents of which are incorporated herein by reference.

### TECHNICAL FIELD

The following relates generally to automated remediation of processes in computerized systems.

### BACKGROUND

Computerized systems have grown in complexity over time, and that growth has caused challenges in implementing efficient interfaces between computerized systems and other types of systems. The growth in complexity can also make certain computerized processes that are difficult to integrate into particular workflows.

Remediation of computerized system workflows are an example of a workflow where computerized systems can be difficult to integrate. Computerized systems can fail in unexpected manners. The failure can include technical components unrelated to the outcome of the workflow (e.g., certain data is improperly formatted). The failure can be difficult to identify (e.g., error occurs in unexpected computerized process of a workflow) and can be opaque (e.g., requires a detailed knowledge of older computerized systems, requires different permissions in different systems, etc.).

Existing remediation systems are similarly prone to undesirably performance: they can identify errors in specialized manners, the error identifier can be difficult to parse, hard to access, etc.

Maintaining remediation systems for computerized systems, like the underlying computerized systems, is also a difficult technical challenge. The remediation system must adapt to changing underlying computerized systems and the related workflows.

The above listed challenges also grow in size with the increase in the size of the computerized system, or the speed at which the remediation is expected to occur.

Improvement is desirable. For example, implementing a remediation system that can increase the useability of remediation systems, increase the number of users able to implement remediation, or how to maintain existing remediation systems or integrate remediation systems with less effort is desirable.

### BRIEF DESCRIPTION OF THE DRAWINGS

Embodiments will now be described with reference to the appended drawings wherein:

FIG. 1 is a schematic diagram of an example computing environment.

FIG. 2A shows a block diagram of a workflow for automated remediation.

FIGS. 2B and 2C each show a block diagram of different example workflows for rapid fund transfers of funds via an intermediary.

FIG. 3 is a step diagram of an example workflow as disclosed herein.

FIG. 4 is a block diagram of an example configuration of an enterprise system.

FIG. 5 is a block diagram of an example configuration of a user device.

FIG. 6 is a flow diagram of an example method for at least in part automating remediation in an enterprise system.

FIG. 7 is a flow diagram of an example method performed by computer executable instructions for rapid fund transfers of funds via intermediary.

FIG. 8 is a flow diagram of an example method performed by computer executable instructions for correcting errors of rapid transfers of funds via intermediary.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

Performing remediation for processes that involve computerized systems is increasingly a difficult technical task. Technically skilled individuals may be required to perform investigations into the operations of the computerized systems. Professionals with domain expertise (e.g., accountants) can also be required instruct the technically skilled individuals in their investigation. The different individuals with potentially different specialties can be required to coordinate in real time (e.g., the developer needs to talk with a front end representative of an enterprise).

Determining the correct remediation effort is similarly difficult. Technical solutions can be difficult to determine, certain solutions can be dismissed due to other considerations (e.g., regulatory considerations), etc.

To conclude, detection of failure and remediation of computerized systems is technically challenging and can involve expense expertise, which expertise may need to be coordinated.

The required expertise arises from or is intertwined with knowledge of the computerized system, and is therefore necessarily rooted in computer technology. That is, to use an example related to a financial institution, how payments are treated by a computerized system includes technical expertise on how that data is stored in the database, how related events are managed, and professional expertise can include understanding of how certain databases are treated for trust law purposes, etc.

A device, method, and computer readable medium for at least in part automating remediation in an enterprise system is disclosed here. The method, for example, can democratize remediation of difficult technical tasks via an automated remediation platform that monitors events performed by the enterprise to determine failures. For example, the remediation platform can include a plurality of machine learning models trained to monitor events, with the training data being supplied by technical staff.

The remediation platform can generate notification events to users capable of implementing the remediation, democratizing the remediation process. For example, the platform can generate notifications to individuals that include a series of options to remediate the failure, thereby converting the technical expertise used to train the machine learning model into actionable insights to non-technical staff. This conversion can remove the opacity with some existing remediation systems.

Logistics issues associated with remediation are also remedied. A failure can be automatically detected, removing the need for failure detection by personnel, and the notification and personnel management required to direct detected failures towards the individuals capable to resolving the failure.

In one aspect, a device for at least in part automating remediation in an enterprise system is disclosed. The device includes a processor, a communications module coupled to the processor, and a memory coupled to the processor. The memory stores computer executable instructions that when executed by the processor cause the processor to receive a request to perform an action, the action requiring at least one of a plurality of subsystems to be completed, the plurality of subsystems comprising employee and customer subsystems, and transmit an event, based on the request, to the at least one of a plurality of subsystems via an event subsystem. The instructions cause the processor to with an automated remediation platform: monitor events sent from the at least one of a plurality of subsystems to the event subsystem to detect a failure, and in response to detecting the failure, generate a trigger event for consumption by the event subsystem. The instructions cause the processor to in response to receiving the trigger event, transmit a remediation event for consumption by the at least one of a plurality of subsystems.

In another aspect, a method for at least in part automating remediation in an enterprise system is disclosed. The method includes receiving a request to perform an action, the action requiring at least one of a plurality of subsystems to be completed. The plurality of subsystems include employee and customer subsystems. The method includes transmitting an event, based on the request, to the at least one of a plurality of subsystems via an event subsystem. The method includes with an automated remediation platform: monitoring events sent from the at least one of a plurality of subsystems to the event subsystem to detect a failure; and in response to detecting the failure, generating a trigger event for consumption by the event subsystem. The method includes in response to receiving the trigger event, transmitting a remediation event for consumption by the at least one of a plurality of subsystems.

In another aspect, a non-transitory computer readable medium for at least in part automating remediation in an enterprise system is disclosed. The computer readable medium includes computer executable instructions for receiving a request to perform an action, the action requiring at least one of a plurality of subsystems to be completed. The plurality of subsystems include employee and customer subsystems. The instructions are for transmitting an event, based on the request, to the at least one of a plurality of subsystems via an event subsystem. The instructions are for, with an automated remediation platform: monitoring events sent from the at least one of a plurality of subsystems to the event subsystem to detect a failure; and in response to detecting the failure, generating a trigger event for consumption by the event subsystem. The instructions are for, in response to receiving the trigger event, transmitting a remediation event for consumption by the at least one of a plurality of subsystems.

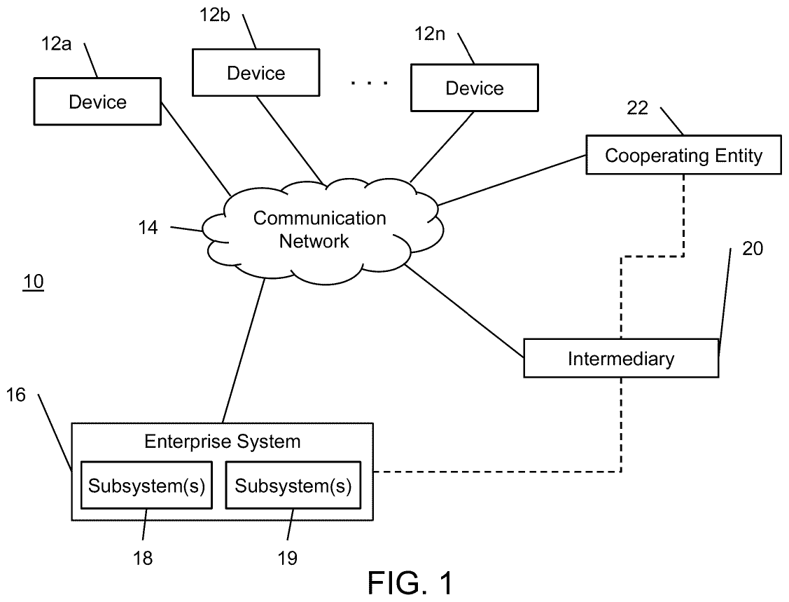

FIG. 1 illustrates an exemplary computing environment 10. The computing environment 10 can include one or more user devices 12 (shown as user devices 12a, 12b . . . 12n), an enterprise platform 16, an intermediary 20, a cooperating entity 22, and a communications network 14 connecting one or more components of the computing environment 10.

The enterprise system 16 (e.g., a financial institution such as commercial bank and/or lender) can be a system that provides a plurality of services via a plurality of subsystems (e.g., the shown subsystems 18, 19). For example, a service 18a can incorporate a payment subsystem, the service 18a can incorporate a wealth management account subsystem, or an event management subsystem. The enterprise system 16 can a variety of subsystems, including a distribution subsystem, a customer subsystem, an employee subsystem, a multitenant subsystem, etc.

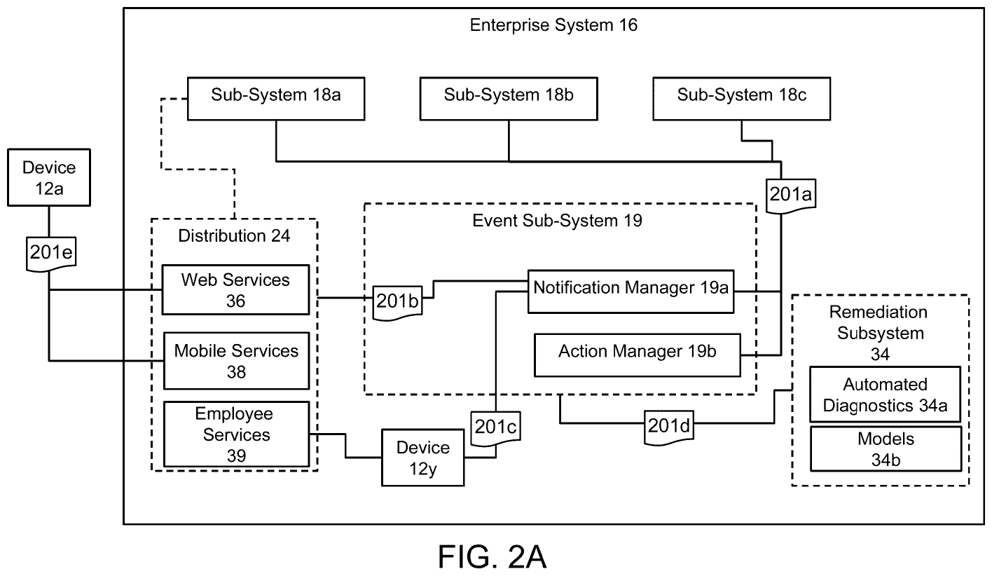

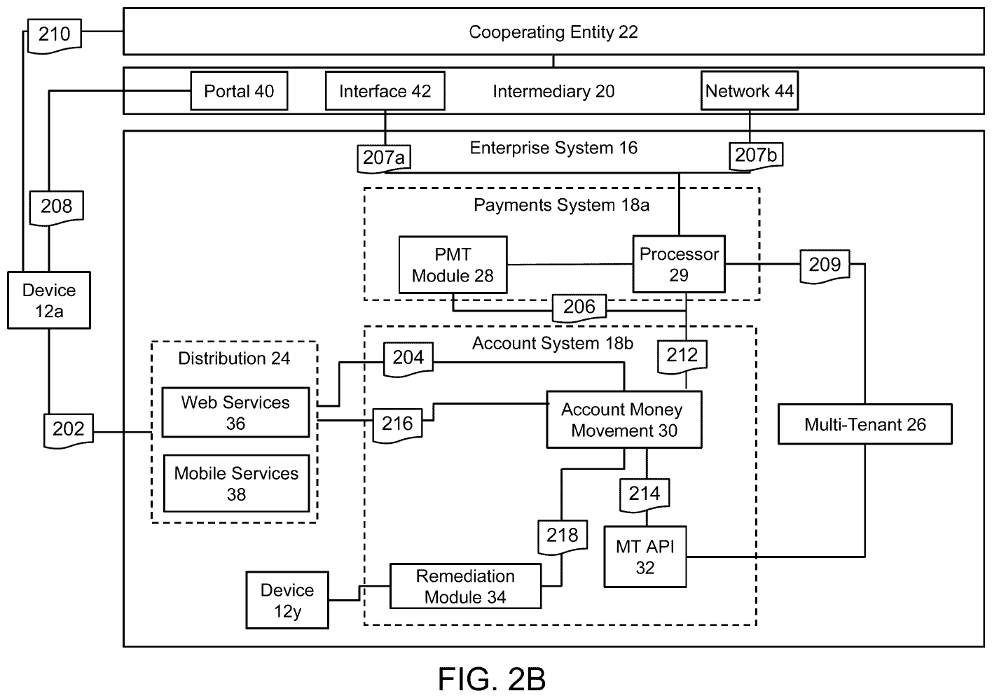

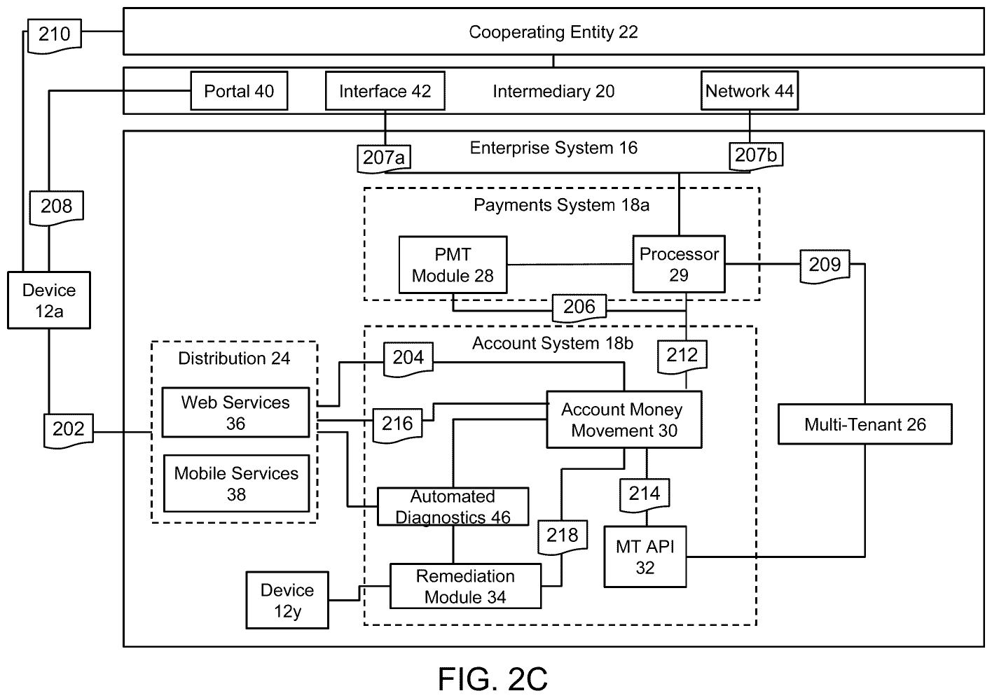

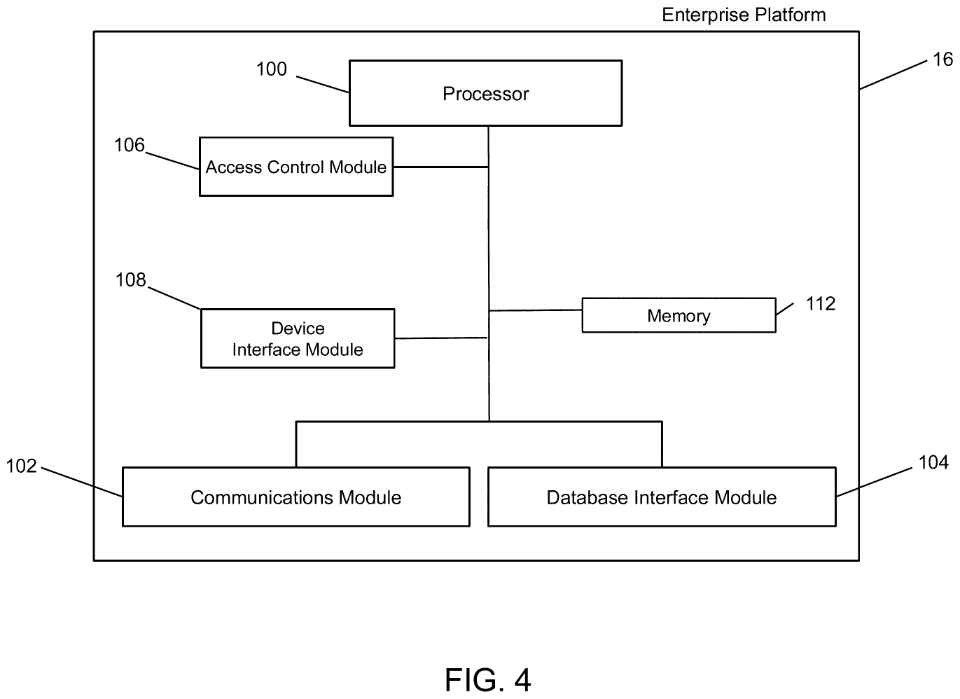

The services of the enterprise system 16 can be provided by computing resources controlled by the enterprise system 16 (e.g., via dedicated hardware), or through resources marshaled by the enterprise system 16, such as cloud computing resources. While several details of the enterprise system 16 have been omitted for clarity of illustration, reference will be made to FIGS. 2A, 2B, 2C and 4, below for additional details.

User devices 12 may be associated with one or more users. Users may be referred to herein as customers, clients, users, investors, depositors, employees, contractors, correspondents, or other entities that interact with at least one of the enterprise system 16, the cooperating entity 22, and/or intermediary 20 (directly or indirectly). The computing environment 10 may include multiple user devices 12, each user device 12 being associated with a separate user or associated with one or more users. The client devices can be external to the enterprise system (e.g., the shown devices 12a, 12b, to 12n), or internal to the enterprise system 16 (not shown). In certain embodiments, a user may operate user device 12 such that user device 12 performs one or more processes consistent with the disclosed embodiments. For example, the user may, via the user device 12, generate requests to transfer funds, provide parameters associated with the fund transfer, etc.

User devices 12 can include, but are not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of user devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet).

Intermediary 20 can be an entity that coordinates funds transactions between the cooperating entity 22 and the enterprise system 16 (e.g., Interac™). The intermediary 20 can be an entity that solely focuses on interbank transactions, that focuses on interbank transactions between specific parties, the provides intermediary services as one of many services, etc. To process funds transactions, the intermediary 20 can impose a variety of different technical constraints. For example, the intermediary can provide an application programming interface (API) that enforces a particular technical protocol to rely on the intermediary 20 services.

The cooperating entity 22 (it is understood that there can be a plurality of cooperating entities) is an entity that maintains funds intended to be transferred to the enterprise system 16, or a similar transaction. In an example embodiment, the cooperating entity 22 is another financial institution. The cooperating entity 22 can be in communication with the intermediary 20 to facilitate transfers of funds to/from the enterprise system 16.

The intermediary 20, cooperating entity 22, and/or enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public, and private keys in a PKI), and perform other cryptographic operations that are required or desired for particular applications of the intermediary 20 or enterprise system 16. The cryptographic server may, for example, be used to protect the financial data and/or client data and/or transaction data within the enterprise system 16 by way of encryption for data protection, digital signatures or message digests for data integrity, and by using digital certificates to authenticate the identity of the users and user devices 12 with which the enterprise system 16 and/or intermediary 20 communicates to inhibit misuse by adversaries. It can be appreciated that various cryptographic mechanisms and protocols can be chosen and implemented to suit the constraints and requirements of the particular deployment of the intermediary 20 or enterprise system 16 as is known in the art.

FIG. 2A provides a block diagram of an example workflow for at least in part automating remediation in an enterprise system.

As shown in FIG. 2A, the enterprise system 16 can include a plurality of subsystems 18 (shown illustratively as subsystems 18a, 18b, and 18c). The subsystems 18a to 18c can include employee and customer subsystems, or employee and customer subsystems can be separately integrated within, or communicate with the plurality of subsystems 18. For example, the subsystem 18a can be a wealth management subsystem, and employees performing tasks associated therewith can do so within the subsystem 18a (e.g., open a new account, change an amount charged, etc.).

Each of the subsystems 18 can be configured to generate events 201a in response to actions taken within the subsystem. For example, the subsystems 18 can send an event in response to performing an action, or in response to a change in a particular database managed by the subsystem, etc. In another example, the subsystems 18 can generate events in response to receiving input of a failure. For example, a customer compliant can result in the subsystem 18 automatically generating an event. Similarly, the event 201a shows that the event subsystem 19 (as described herein) can generate events to notify the subsystems 18 of an occurrence. For example, the subsystems 18 can receive events 201 such as a trigger event that causes the subsystem to perform one or more actions.

An event subsystem, denoted by subsystem 19 in FIG. 2A for simplicity, can be configured to receive events or send events. Events 201a can be sent from the at least one of a plurality of subsystems 18 directly to the event subsystem 19, or the event subsystem 19 can send events 201a to the at least one of the plurality of subsystems 18. Similarly, the event subsystem 19 can send or receive events from other subsystems, directly or indirectly. For example, the event subsystem 19 can receive events 201e (e.g., customer complaints) from customer devices 12a interacting with the subsystems 18 via a distribution subsystem 24 event 201b. The event subsystem 19 can receive action events 201c from an employee device 12y interacting directly with the event subsystem 19 to remedy failures. The event subsystem 19 can receive or send events 201d based on interactions with a remediation subsystem 34.

The enterprise system 16 can include the distribution subsystem 24. The distribution subsystem 24 can be a subsystem for distributing information stored in the subsystems 18, or facilitating interaction with same. In the shown embodiment, the distribution subsystem 24 includes a web services module 36, a mobile services module 38, and an employee services module 39. Each module can manage communications from different channels. The web services module 36 can be maintained to enable customers to interact with subsystems 18 via the internet (e.g., via a desktop computer browser), the mobile services module 38 can enable communication between the device 12a (e.g., a customer device) and the subsystems 18 through a dedicated mobile application (e.g., an application developed by a financial institution enterprise 16), and the employee module 39 can facilitate interactions between employees (e.g., logging in through employee specific software, hardware (e.g., device 12y) or channels). Although not shown, the distribution subsystem 24 can also be used to facilitate communication with the multitenant system 26 (as discussed herein) to parties external to the enterprise system 16.

The enterprise system 16 can include the remediation subsystem 34. The remediation subsystem 34 can include an automated diagnostics module 34a, and a model repository 34b. The model repository 34b can include one or more models trained to detect different failures. For example, a first model can be trained to detect failures in a transfer systems, another model can be trained to detect failures in opening a new account, yet another model can be trained to detect issues in a mobile device, etc. The models can be trained based on training examples curated by technically skilled professionals. For example, a programmer with experience in financial systems can generate training data of technical failures (e.g., a certain subsystem 18, 24, 19, is unresponsive as it is waiting for an event from another subsystem, or has timed out, etc.). Training data can be updated based on new implementations, resolved failures, feedback, etc., and the models can be training again on the updated training data. The training data can also include data that allow for technical failures to be resolved. For example, the training data can specify that certain memory needs to be cleared, that certain transactions need to be reconciled in different databases, etc. The training data can include non-technical data, such as curated options to present to a less technically capable employees to allow for resolution of detected failures. For example, the training data can include actions, (e.g., sample correspondence such as emails) to send to technical staff (e.g., the following error with designation XYZ has been detected for transaction number, xyz. You are authorized to resolve the error as documented in XYZ.), or actions to take to resolve the failure (e.g., steps to restart a process associated with a customer opening a new account, etc.), etc.

Each of the different models can be trained to monitor events that involve different combinations of the plurality of subsystems. By monitoring in this way, the different models can include carefully curated training data is not unwieldy. The technical and other expertise required to generate the model, to update the model, etc., is less compared to a one size fits all model. In addition, the models are relatively small, allowing for quick if not real-time monitoring.

The automated diagnostics module 34a can be configured to pull events from the event subsystem 19 (or the event subsystem 19 can be configured to push events to the automated diagnostics module 34a, e.g., via subscriptions to event topics) and monitor the events for indications of a failure. Events can be monitored on the basis of the one or more models stored in the model repository 34b. The automated diagnostics module 34a can, for example, monitor events from each of a wealth management, a payments, and an enterprise account subsystem with different models from the repository 34b. Detected failures can be associated with an identifier, to allow for tracking. Other subsystems 18, 19, 34, can be configured to use the identifier for events or actions associated with the failure to facilitate tracking.

The automated diagnostics module 34a can generate a trigger event for consumption by the event subsystem 19. As remediation of the failures can intentionally be routed through the event subsystem 19 to avoid the need to update remediation processes every time there is a change in the underlying subsystem 18, the trigger event can processed by the event subsystem 19 to generate a remediation event for consumption by one of the subsystems 18. That is, in at least some scenarios, the automated diagnostics module 34a can consume events received from the event subsystem 19, and only send events to the event subsystem 19 in response to detecting a failure.

The remediation event can be an action event, or a notification event. The action event can be an action determined by the automated diagnostics module 34a which can resolve a failure. For example, the action event can include restating a certain server, clearing a particular queue, etc.

The notification event can be a notification to a technical or non-technical employee to take steps to resolve the detected failure (e.g., the action cannot be taken without authorization). For example, the notification event can be an email to a non-technical employee received via an employee subsystem of the plurality of subsystems 18, 19, 24 that can include instructions to complete a non-technical remediation (e.g., provide a necessary approval), or to communicate with individuals capable of resolving the failure (e.g., the employee can liaise with technical staff, or the customer). The notification event to technical employee, such as an email or a task in task management software, to remedy the identified failure.

The notification event can include one or more likely options for remedying the failure. For example, one option can include actions from the customer, which the employee can relay to a customer. Another option can include a fix by a technical staff. Yet another option can include an alternative process that includes a greater amount of approvals.

Notification events can be managed by a dedicated notification event manager 19a of the event subsystem 19. Action events can be managed by a dedicated action event manager 19b. By separating the two events, updating and maintenance can be simplified. Action items can also, in example embodiments, require more strict oversight given the automated nature of the action, and so access to the action event manager 19b can be more controlled and limited (e.g., only technical staff have the ability to configure the action manager, and to be notified of events associated with eh action manager 19b).

The automated diagnostics module 34a can monitor events from the event subsystem 19 to determine if a remediation event has been completed, or is effective, or the degree of effectiveness. For example, the automated diagnostics module 34a, with another model or based on programmed logic, can be trained to identify if an action item was successful (e.g., the failure is resolved), of if the remediation options of a notification event are occurring (e.g., has the employee authorized the necessary changes), etc.

FIG. 2B provides a block diagram of an example workflow for rapid fund transfers of funds flowing through an intermediary 20 that includes automated remediation. As shown in the example embodiment, the enterprise system 16 can include the payment service 18a, the account management service 18b as well as a distribution subsystem 24, and a multitenant subsystem 26.

The payment service 18a can include a payment API 28 for communicating with the account management service 18b. The API 28 can be configured to receive requests to perform fund transfers from the account management service 18b, via the account management module 30. The payment service 18a can also include a processor 29 which complies with regulatory and industry-standard requirements for processing payments. The processor 29 can be configured to operate according to, for example, the international standards organization (ISO) 20022 framework. As a result of regulatory and risk considerations, the processor 29 can be limited to routing transactions to the multitenant subsystem 26.

The multitenant subsystem 26 can include one or more holding accounts for storing payments processed to the current processor 29. For example, the multitenant subsystem 26 can include general accounts maintained by the enterprise system 16, which general accounts are used to fund a plurality of client accounts within the account service 19, etc.

The account management service 18b can include an account management module 30, a multitenant API 32, and a remediation module 34. The account management module 30 can be responsible for processing requests to transfer funds from a first type of account (e.g., a wealth account type), whether for investment purposes or for fund transfer requests, etc. The multitenant API 32 can be responsible for facilitating communication between the account management module 30 and the multitenant subsystem 26. The remediation module 34 can enable one or more remedial or diagnostic actions in response to a transfer request.

A diagnostic action can include a variety of actions, including, but not limited to, a query to a component of the payment service 18aa or the account management service 18b to determine whether a particular operation has been completed, a query to the intermediary 20 to determine whether a request has been processed or completed, generating a task list for a reviewer to complete (e.g., a checklist that can be generated for a remote technician maintaining the accounts of the service 18b to determine if all components of the service 18b are functioning as intended), and operations to collect events generated by the components of the system 16, etc.

A remedial action can include a variety of actions to address diagnosed, or undiagnosed, circumstances which can result in the failing of the fund transfer. For example, a remedial action can include generating a fund transfer from the multitenant subsystem 26 to the account within the account management service 18b, providing confirmation of an event to the multitenant subsystem, providing confirmation of an attempt to the processor 29, resetting components of the enterprise system 16, etc.

The remediation module 34 can be connected to a device (shown as device 12y) operated by a user (e.g., a reviewer) authenticated to implement remedial or diagnostic actions. For example, the remediation module 34 can be accessed by technical support staff associated with maintaining the account management service 18b.

In the shown embodiment, the intermediary 20 includes a portal 40 for communicating with user devices, and an interface 42 for communicating with enterprise systems 16 that are registered to the network 44. The intermediary 20 can also communicate with the operating entity 22.

FIG. 2B also shows various channels that can be used to perform rapid fund transfers via the intermediary 20. What follows is a description of an example workflow to perform rapid fund transfers, it is understood that the example workflow is illustrative, and variations are contemplated.

A request 202 (e.g., sent via the communication network 14), from the device 12a to perform a fund transfer of funds from an account in the cooperating entity 22 to an account managed by the account management service 18b of the enterprise system 16 is received at the distribution subsystem 24. The request 202 can specify that the fund transfer should occur via the intermediary 20, or a component of the enterprise system 16 can determine that the intermediary 20 is required to satisfy the fund transfer (e.g., satisfy a timeliness parameter associated with the requested fund transfer), etc.

In example embodiments, although not shown, the request received at the distribution service 24 can be funneled for subsequent processing through a centralized module. For example, the mobile services module 38 can be configured to send all requests to the web services module 36 for further processing.

The distribution subsystem 24 may be able to determine that applicable enterprise system 16 service associated with the request 202. For example, the distribution subsystem 24 may determine that the request 202 relates to an account, or an account type managed by the account management service 18b.

In response to determining that the account management service 18b is maintaining the account, or type of account, associated with the request 202, the distribution subsystem 24 (e.g., the web services module 36) can route a request 204 (e.g., a call, including the details received in the request 202) to the account management module 30 of the account service 19 to initiate the fund transfer.

The account management module 30 can be configured to direct the request 204 to the payment API 28, to complete the fund transfer via the payment service 18a. In example embodiments, the management module 30 generates a new request 206 to the payment API 28 based on the request 204, as shown. In at least some example embodiments, the request 206 can include the account management module 30 calling the payment processor 29 (via the payments API 28) to create a payment transaction and get a transaction ID and a Uniform Resource Locator (URL) associated with the intermediary 20 (e.g., and Interac™ URL) for completing the transaction (hereinafter referred to as the intermediary transaction parameters).

In example embodiments, a separate event is generated denoting that the distribution service 24 has provided the request to the money movement account 30. This event can be used, subsequently, for comparison purposes to ensure that the submitted transaction maps onto the completed transaction.

The processor 29 can at least in part be responsible for generating the intermediary transaction parameters. For example, the request 206 can be provided by the payment API 28 to the processor 29, which can communicate with an interface 42 of the intermediary 20 via requests 207a to retrieve the intermediary transaction parameters.

In at least some example embodiments, the processor 29 is at least in part responsible for populating the request 207a. For example, the processor 29 can populate the request 207a with a transaction ID assigned by the processor 29, information related to accounts which will receive the funds transferred via the intermediary 20, etc.

The intermediary transaction parameters can be provided to the device 12a which requested the fund transfer to receive further information. For example, the channels used to route the request 202, 204, and 206, can be utilized to transmit the intermediary transaction parameters back to the device 12a.

Based on the intermediary transaction parameters, the device 12a can connect to the portal 40 of the intermediary 20. For example, the device, upon receipt of the URL, can be directed to the intermediary 20 webpage. In example embodiments, all actions of the device 12 occur within an interface controlled by the enterprise 16, such that a user is not required to exit an interface to complete the fund transfer (e.g., the URL is able to be processed by the enterprise application installed on the user device 12a).

The intermediary 20 may require a plurality of parameters to complete the requested fund transfer. For example, the parameters can include the identity of the cooperating entity 22. The requesting and provisioning of these parameters is shown by communication(s) 208.

In example embodiments, the plurality of parameters are provided in part to the intermediary 20, and in part to the cooperating entity 22. For example, the intermediary may route the device 12a to the selected cooperating entity 22 to input the remaining parameters necessary to complete the fund transfer. In the embodiment shown, a request 210 is provided to the cooperating entity 22 to facilitate the transfer. The request 210 can include authenticating the device 12a user with the cooperating entity 22, identifying the account which will be used to fund the fund transfer, etc.

Referring again to the payment processor 29, the payment processor 29 can be configured to listen to events from a network 44 operated by the intermediary 20 to determine if the fund transfer associated with the request 202 has been completed. The processor 29 can be configured to push or pull these events.

In response to receiving confirmation that the transfer has been processed by the intermediary 20, shown as confirmation 207b, the processor 29 can generate an event for the account management module 30 (e.g., shown as event 212) notifying the account management module 30 that transfer has been completed.

The processor 29 can also, because of technical regulatory and risk requirements, process a deposit (e.g., shown as deposit 209) to a multitenant account in the multitenant system 26. The processing of the deposit into the multitenant account can occur via a specialized API, similar to the multitenant API 32 of the account management service 18b.

In response to receiving the event 212 from the processor 29, the account management module 30 can post a transaction 214 to the wealth client account within the multitenant subsystem 26 via the multitenant API 32. This enables the legacy multitenant subsystem 26 to reconcile the transactions in near real time, as confirmation is received from the payment service and the service which manages the account.

The account management module 30 can also be configured to send events indicative of the completion of the transaction to the distribution services (e.g., shown as event 216) and the remediation module 34 (e.g., shown as event 218).

By making the account management module 30 a hub which coordinates events based on events generated by the processor 29, rapid fund transfers can be performed. The difficulties associated with reconciliation of the multitenant accounts in the multitenant subsystem 26 are alleviated as the account management module 30 depends on an event generated by the processor 29 indicating that the funds have been received from the intermediary 20. As a result, reconciliation can occur almost instantaneously by having the money movement account 30 receive confirmation of the completion be the intermediary 20, and posting the transaction to the multitenant subsystem 26 via the multitenant API 32.

In addition, having the account management module 30 post events to both the remediation module 34 (if required) and the web services module 36 enables a transparent system such that the customer can see the funds processing in real-time.

By basing the disclosed architecture on events generated by the payment processor 29, and events generated or received by the account management module 30, it can be relatively easy to perform diagnostic operations to determine technical errors associated with the transfer. For example, a common error associated with fund transfers is that certain asynchronous events can be stalled in processing, and certain dependent events can as a result timeout. For example, if the funds are not received from the intermediary 20, the payment service 18a may timeout. In the disclosed architecture, events can strategically be placed around communications to and from the account management module 30 and the processor 29 to determine likely components involved with failures. For example, if a confirmation event 212 is not received from the processor 29, a smaller subset of diagnostic tools may be required to determine the error in the fund transfer.

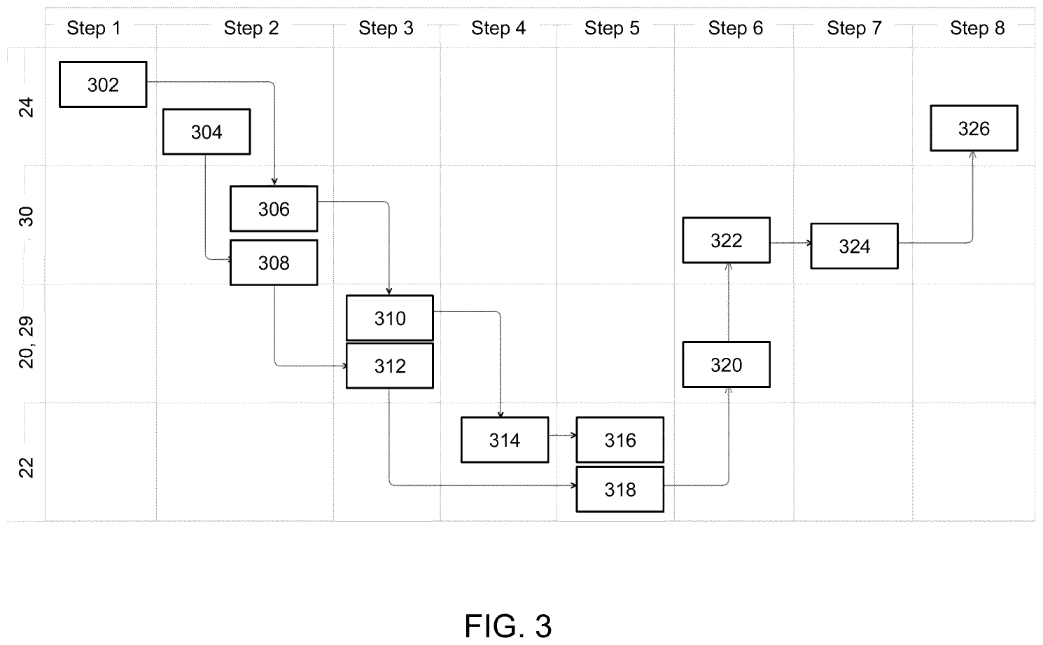

FIG. 3 shows a step diagram of an example workflow as disclosed herein. It is understood that any reference to the preceding figures is illustrative, and not intended to be limiting.

At block 302, the device 12a authenticates with the enterprise system 16 via the distribution subsystem 24. The authentication system can be two factor authentication, password only authentication, etc.

At block 304, the distribution subsystem 24 receives a request (e.g., request 202) to transfer funds via an intermediary 20. The request can be received via the channel used to authenticate the device 12a (e.g., a dedicated enterprise application), indirectly via the remediation module 34 (not shown), in instances where an owner of the devices attempting to perform telephone banking, etc.

At block 306, the device 12a is required to authenticate with the account management service 18b. As the account management service 18b can be used to manage a particular type of account (e.g., a wealth account) with technical limitations resulting from regulatory and risk circumstances, and additional authentication may be required. In example embodiments, the distribution subsystem 24 provides the authentication information provided in block 302 to the account management module 30 to complete authentication.

At block 308, the distribution subsystem 24 submits the request (e.g., request 204) to transfer funds to the account management module 30. In example embodiments, the request 204 is provided to the account management service 18b automatically, and the account management module 30 is responsible for determining whether an account managed by the account management service 18b is implicated in the request 204.

The account management module 30 can determine an account associated with the received request 204. The account management module 30 can confirm that the request pertains to a particular type of account (e.g., a wealth account) which may be technically limited as a result of the regulatory address requirement. For example, only certain account types may have access to request transfers via the account management module 30, which requested transfers follow the following process to enable rapid fund transfers via the intermediary 20.

At block 310, the account of the enterprise system 16 associated with the request can be identified, or the use of the rapid fund transfer process can be selected. For example, device 12a can input an account capable of performing the rapid fund transfers, or can expressively select a rapid fund transfer as an option.

At block 312, the transaction details can be created by the payment processor 29 and the intermediary 20. Block 312 can include the creation of the intermediary transaction parameters, for example.

At block 314, the device 12a can provide input identifying the relevant cooperating entity 22. Block 314 can also include the device 12a providing information as to which account from the identified relevant cooperating entity 22 is to be used to fund the transfer request.

At block 316, the device 12a authenticates with the cooperating entity 22.

As a result of block 316, at block 318, the transaction created in block 312 can be authorized by the cooperating entity 22, and confirmation can be provided to the intermediary 20.

At block 320, the intermediary 20 can provide confirmation to the payment processor 29 that the transaction has been completed. In example embodiments, the payment processor 29 monitors events in the network 44 to determine whether the transaction has been authorized within the intermediary 20.

At block 322, the payment processor 29 provides notification of the confirmation of block 320 to the account management module 30.

At block 324, the money management module 30 posts the transfer to the multitenant subsystem 26. Block 324 can also include the account management module 30 notifying the remediation services 34 of completion of the fund transfer.

At block 326, the account management module 30 provides notification of the completed transaction to the distribution subsystem 24.

Referring now to FIG. 2C, a block diagram of another example workflow for rapid fund transfers of funds via an intermediary 20 that includes automated remediation is shown.

In the embodiment shown in FIG. 2B, the account management service 18b also includes an automated diagnostics module 46. The automated diagnostics module 46 can include the machine learning model trained to detect errors in fund transfers. For example, the machine learning model of the automated diagnostics module 46 can be trained with previous instances where fund transfers failed, and the diagnostic and remedial actions taken to resolve the previous failed instances. In this way, the machine learning model can be trained to predict appropriate diagnostic actions, predict appropriate remediation actions, etc. In at least some example embodiments, the machine learning model is used to monitor events associated with fund transfers to automatically determine if there has been an error.

The automated diagnostics module 46 can be in communication with the remediation module 34 and the distribution subsystem 24. The automated diagnostics module 46 can communicate with the remediation module 34 to recommend and provide one or more diagnostic actions to a reviewer, operating device 12y. In example embodiments, the automated diagnostics module 46 directs the generated recommended diagnostics actions to a device 12a associated with a reviewer having the authentication necessary to implement the diagnostic actions. For example, the automated diagnostics module 46 can access an approved list of individuals to notify depending on the recommended diagnostics actions provided by the machine learning model. Similarly, the automated diagnostics module 46, in response to determining that the diagnostic actions include actions to be performed by the requester, can be at the distribution subsystem 24 provide the diagnostic events to the device 12a for completion.

As alluded to above, the automated diagnostics module 46, via the machine learning model, can also be trained to generate one or more remediation actions. The remediation actions can similarly be routed to individuals with authentication to perform such actions.

In example embodiments, the automated diagnostics module 46 performs at least one generated diagnostic action automatically. In this way, the automated diagnostics module 46 can be configured to exhaust diagnostic actions that do not require the input of an authenticated user to the device 12y.

Referring now to FIG. 4, an example configuration for the enterprise system 16 is shown. In certain embodiments, the enterprise system 16 may include one or more processors 100, a communications module 102, and a database interface module 104 for enabling interfacing between subsystems to retrieve, modify, and store (e.g., add) data. Communications module 102 enables the enterprise system 16 to communicate with one or more other components of the computing environment 10, such as user device 12 (or one of its components), via a bus or other communication network, such as the communication network 14. The enterprise system 16 includes at least one memory or memory device 112 that can include a tangible and non-transitory computer-readable medium having stored therein computer programs, sets of instructions, code, or data to be executed by processor 100.

FIG. 4 illustrates examples of modules, tools and engines stored in memory 112 on the enterprise system 16 and operated or executed by the processor 100, but intentionally omits components described in FIGS. 2A, 2B to maintain visual clarity. It can be appreciated that any of the modules, tools, and engines shown in FIG. 4 may also be hosted externally and be available to the enterprise system 16, e.g., via the communications module 102.

In the example embodiment shown in FIG. 4, the enterprise system 16 includes an access control module 106, and a device interface module 110. The access control module 106 may be used to apply a hierarchy of permission levels or otherwise apply predetermined criteria to determine what aspects of the enterprise system 16 can be accessed by user devices 12, intermediary 20, etc., such as what resources the devices 12can access, and/or how related data can be shared with which entity in the computing environment 10. As such, the access control module 106 can be used to control the sharing of resources or aspects of the system 16 based on a type of client/user, a permission or preference, or any other restriction imposed by the computing environment 10 or application in which the system 16 is used.

The device interface module 110 can provide a graphical user interface (GUI), software development kit (SDK) or API connectivity to communicate with the enterprise system 16. It can be appreciated that the device interface module 110 may also provide a web browser-based interface, an application or “app” interface, a machine language interface, etc.

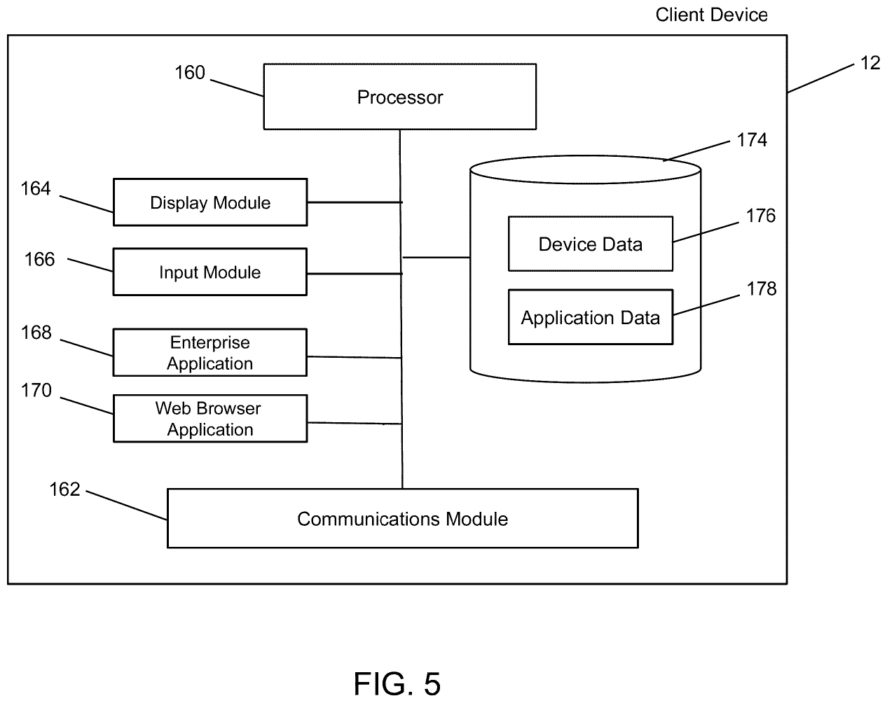

In FIG. 5, an example configuration of a user device 12 is shown. In certain embodiments, the user device 12 may include one or more processors 160, a communications module 162, and a data store 174 storing device data 176 (e.g., data needed to populate a request 13, or to perform a remediation action) and application data 178. Communications module 162 enables the user device 12 to communicate with one or more other components of the computing environment 10, such as intermediary 20, or enterprise system 16, via a bus or other communication network, such as the communication network 14. While not delineated in FIG. 5, similar to the intermediary 20 the user device 12 includes at least one memory or memory device that can include a tangible and non-transitory computer-readable medium having stored therein computer programs, sets of instructions, code, or data to be executed by processor 160. FIG. 5 illustrates examples of modules and applications stored in memory on the user device 12and operated by the processor 160. It can be appreciated that any of the modules and applications shown in FIG. 5 may also be hosted externally and be available to the user device 12, e.g., via the communications module 162.

In the example embodiment shown in FIG. 5, the user device 12 includes a display module 164 for rendering GUIs and other visual outputs on a display device such as a display screen, and an input module 166 for processing user or other inputs received at the user device 12, e.g., via a touchscreen, input button, transceiver, microphone, keyboard, etc. The user device 12 may also include an enterprise application 168 provided by the enterprise system 16, e.g., for submitting requests to perform mobile banking, investing, or other performing financial services. The user device 12 in this example embodiment also includes a web browser application 170 for accessing Internet-based content, e.g., via a mobile or traditional website and one or applications (not shown) offered by the enterprise system 16 or the intermediary 20. The data store 174 may be used to store device data 176, such as, but not limited to, an IP address or a MAC address that uniquely identifies user device 12 within environment 10. The data store 176 may also be used to store authentication data, such as, but not limited to, login credentials, user preferences, cryptographic data (e.g., cryptographic keys), etc.

It will be appreciated that only certain modules, applications, tools, and engines are shown in FIGS. 2A, 2B, 4 and 5 for ease of illustration and various other components would be provided and utilized by the intermediary 20, enterprise system 16, and user device 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in the enterprise system 16, or the user device 12, or accessible or connectable thereto. Any application or module herein described may be implemented using computer readable/executable instructions that may be stored or otherwise held by such computer readable media.

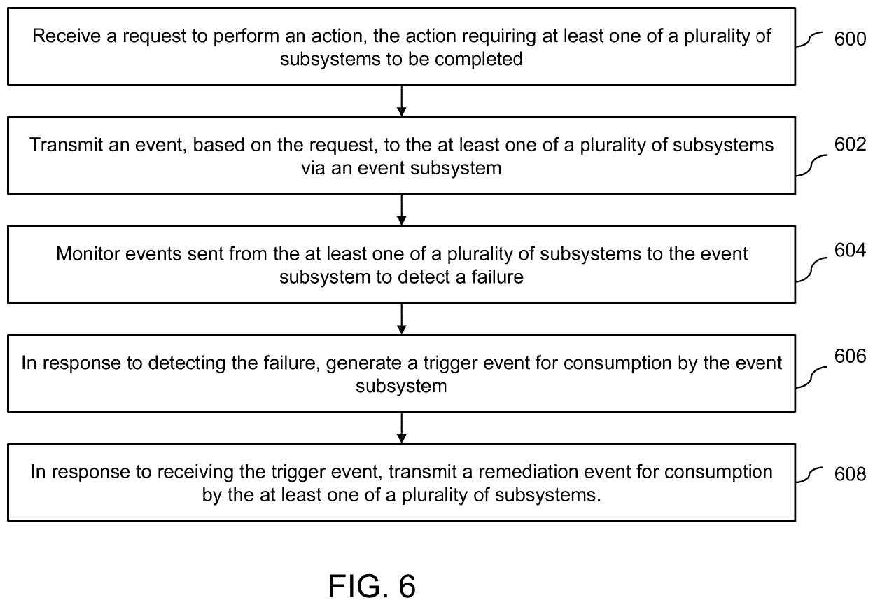

Referring to FIG. 6, a flow diagram of an example method performed by computer executable instructions for at least in part automating remediation in an enterprise system.

At block 600, a request to perform an action is received. For example, the request can include a request to perform a transaction, to open a new account. The disclosure is not limited to financial institution operations, and actions can include updating a database, controlling a physical device (e.g., a gate), etc.

At block 602, an event that is based on the request in block 600 is transmitted to at least one of a plurality of subsystems. The event can be generated by a subsystem 18, or by the event subsystem 19, etc. The event can be a trigger event, causing the subsystem 18 to perform the action associated with the event.

At block 604, events sent from the subsystem(s) 18 to the event subsystem 19 are monitored. For example, the remediation subsystem 34 can monitor events to automatically detect failures with one or more models.

At block 606, with the remediation subsystem 34, in response to detecting the failure in block 604, a trigger event can be generated. The trigger event can be provided to the event subsystem 19 for consumption. The trigger event can specify the failure, an identifier, and one or more options for remedying the detected failure.

At block 608, based on the trigger event, the event subsystem 19 can generate a remediation event for circulation to the relevant subsystem(s) 18. For example, the remediation event can be provided to a payment processing subsystem to clear a particular cache. The event can be a notification event. The event subsystem 19 can be configured to extract the necessary information from the trigger event to determine which subsystem(s) 18 are impacted, and which subsystem(s) 18 need to be alerted to take remediation.

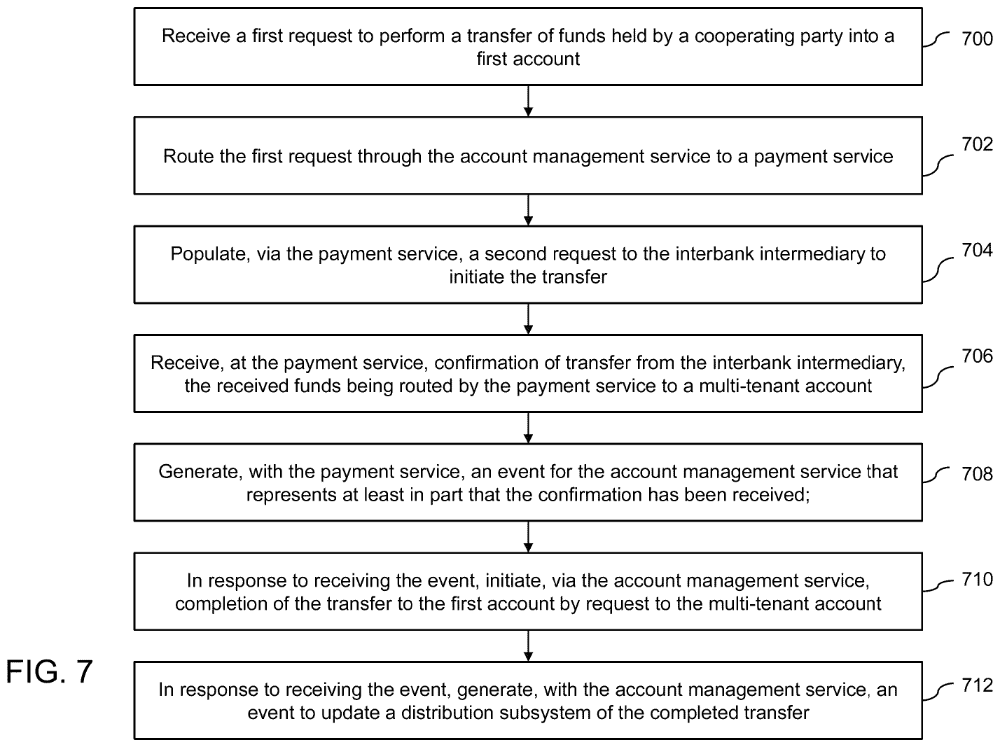

Referring to FIG. 7, a flow diagram of an example method performed by computer executable instructions for rapid fund transfers of funds via intermediary. It is understood that the reference to the preceding figures in FIG. 7 is illustrative, not intended to be limiting.

At block 700, a first request (e.g., request 202) to perform a transfer of funds held by a cooperating entity 22 into an account of the enterprise system 16 is received. The first request can specify that the transfer occurs through an intermediary 20.

At block 702, the first request received in block 702 is routed to a payment service 18a via an account management service 18b. The payment service 18a can be legacy architecture technically constrained to comply with regulatory and risk considerations. The payment service 18a can previously have been used to process payments instead of fund transfers.

At block 704, the payment service 18a populates a second request (e.g., request 207a) to the intermediary 20 to initiate the transfer. Populating the second request can include providing account details to the intermediary bank as to where the transfer funds should be sent, etc.

At block 706, the payment service 18a receives confirmation of the transfer being completed from the intermediary 20 (e.g., the event 207b). The received funds from the intermediary 20 are routed by the payment service 18a to a multitenant account operated by the multitenant system 26 (e.g., event 209).

At block 708, the payment service 18a generates an event (e.g., event 212) to be provided to the account management service 18b. The generated event in block 608 represents at least in part that confirmation has been received in block 606 by the payment service 18a.

The block 710, the account management service 18b, in response to receiving the event in block 708, initiates the completion of the requested transfer to the first account by requesting of the multitenant subsystem 26 that the first account be funded. In example embodiments, the account management service 18b initiates completion of the requested transfer via a dedicated API for correspondence between the multitenant subsystem 26 and the account management service 18b, such as the shown multitenant API 32.

At block 712, the account management service 18b generates an event (e.g., event 218, or events 216) to update the distribution subsystem 24 of the completed transfer. In this way, when the user of the device 12 generates a request, they are notified of completion of the event, or support staff of the enterprise 16 who may be monitoring the fund transfer to the remediation module 34 are notified of the event.

All events generated in response to the transfer request can be assigned a unique ID, such that they are relatively easy to aggregate.

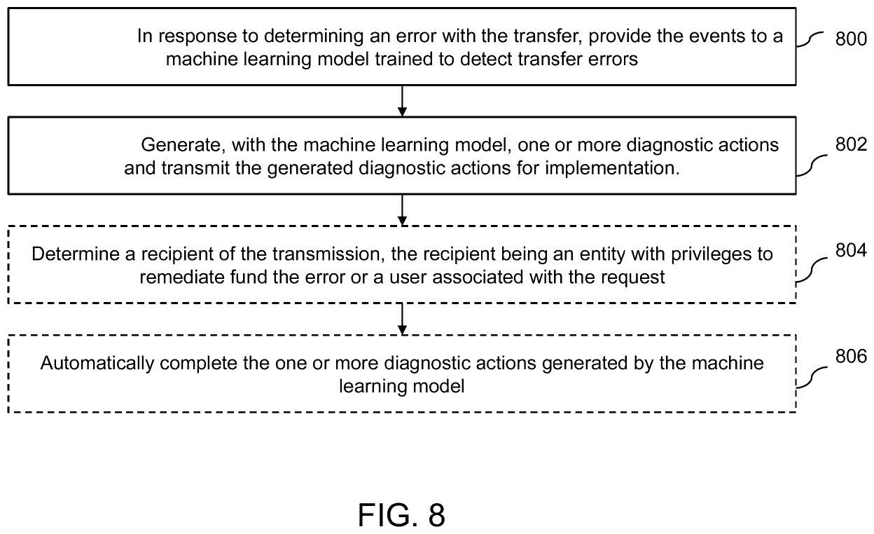

FIG. 8 is a flow diagram of an example method performed by computer executable instructions for correcting errors of rapid transfers of funds via intermediary. It is understood that the reference to the preceding figures in FIG. 8 is illustrative, not intended to be limiting.

At block 800, in response to determining an error with a transfer, for example, within the workflow shown in FIG. 7, the generated events described in FIG. 7 can be provided to the machine learning model trained to detect transfer errors. In example embodiments, the error is determined as a result of input from the device requesting the transfer 12a. For example, a customer may be upset the fund transfer is not completed within a desired time, an employee monitoring the transfer to the remediation module 34 can determine that the transfer has an error, one or more of the components of the enterprise system 16 can have an event listener with a timer which can trigger an error in the event that a particular event is not provided within a threshold, etc.

At block 802, the machine learning model can generate one or more diagnostic actions based on the received events. The diagnostic actions can include user-initiated actions (e.g., actions to be taken by the user device 12a or a device operated by an enterprise system 16 employee), automated actions (e.g., the diagnostic actions can include automatically querying different components or subsystems of the enterprise system 16), generating metadata related to diagnostic actions (e.g., generating checklists for enterprise system 16 staff to perform or evaluate certain diagnostic actions), etc.

At block 804, optionally, a recipient for the transmission of the one or more diagnostic actions is determined. For example, the recipient can be determined based on the privileges required to implement the one or more diagnostic actions. In another example embodiment, the recipient can be determined based on the authentication required to implement related remediation actions. For example, diagnostic actions originating in the interaction between the device 12a and the cooperating entity 22 can be provided to the device 12a for completion. Similarly, diagnostic actions for subsystems of the system 16 can be provided to a system technician of the enterprise system 16.

At block 806, optionally, one or more of the diagnostic actions generated by the machine learning model may be automatically completed. For example, the one or more diagnostic actions can include querying different components of the enterprise system 16 to determine if they are functional, to determine their latency, to determine the latency of a specific operation, to determine the status of operations related to the particular transaction ID assigned to the transfer, etc. Block 806 can be used to perform as many automated diagnostic actions as possible before incorporating the results of these diagnostic actions to a notification provided to a device 12y associated with the technical support staff of the enterprise system 16.

It is understood that the sequence of events shown in FIGS. 6 to 8 are illustrative, and that other sequences are contemplated. For example, block 710 and 712 can be executed simultaneously. In another example, the automatic diagnostic actions of block 806 can be completed prior to determining a recipient for the transmission including the generated diagnostic actions which need to be implemented by a user.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for at least in part automating remediation in an enterprise system, the device comprising:
a processor;
a communications module coupled to the processor; and
a memory coupled to the processor, the memory storing computer executable instructions that when executed by the processor cause the processor to:
receive a request to perform an action, the action including at least one of a plurality of subsystems to be completed, the plurality of subsystems comprising employee and customer subsystems;
transmit an event, based on the request, to the at least one of a plurality of subsystems via an event subsystem;
with an automated remediation platform:
monitor events sent from the at least one of a plurality of subsystems to the event subsystem to detect a failure; and
in response to detecting the failure, generate a trigger event for consumption by the event subsystem; and
in response to receiving the trigger event, transmit a remediation event for consumption by the at least one of a plurality of subsystems.

2. The device of claim 1, wherein the automated remediation platform comprises a plurality of models, each model trained to monitor events that involve different combinations of the plurality of subsystems.

3. The device of claim 1, wherein the automated remediation platform monitors events sent from the at least one of a plurality of subsystems to the event subsystem in real-time to determine the trigger event.

4. The device of claim 1, wherein the plurality of subsystems includes at least two of a wealth management, a payments, and an enterprise account subsystem.

5. The device of claim 1, wherein the remediation event is one of an action event or a notification event to an employee received via an employee subsystem of the plurality of subsystems.

6. The device of claim 5, wherein the notification event comprises one or more likely options for remedying the failure to be performed by the employee.

7. The device of claim 6, wherein the instructions cause the processor to:
with the automated remediation platform, monitor events sent from the at least one of a plurality of subsystems to the event subsystem associated the one or more likely options to determine effectiveness of remediation.

8. The device of claim 5, wherein the event subsystem comprises an automated event manager and a notification manager for receiving, respectively, the action event and the notification event, the notification manager receiving notification of the events from the plurality of subsystems.

9. The device of claim 1, wherein the instructions cause the processor to:
issue the remediation event an identifier that associates monitored events and the failure with the remediation event.

10. The device of claim 1, wherein the instructions cause the processor to:
update the automated remediation platform with a new machine learning model trained to detect a different type of failure.

11. A method for at least in part automating remediation in an enterprise system, the method comprising:
receiving a request to perform an action, the action including at least one of a plurality of subsystems to be completed, the plurality of subsystems comprising employee and customer subsystems;
transmitting an event, based on the request, to the at least one of a plurality of subsystems via an event subsystem;
with an automated remediation platform:
monitoring events sent from the at least one of a plurality of subsystems to the event subsystem to detect a failure; and
in response to detecting the failure, generating a trigger event for consumption by the event subsystem; and
in response to receiving the trigger event, transmitting a remediation event for consumption by the at least one of a plurality of subsystems.

12. The method of claim 11, wherein the automated remediation platform comprises a plurality of models, each model trained to monitor events that involve different combinations of the plurality of subsystems.

13. The method of claim 11, wherein the automated remediation platform monitors events sent from the at least one of a plurality of subsystems to the event subsystem in real-time to determine the trigger event.

14. The method of claim 11, wherein the plurality of subsystems includes at least two of a wealth management, a payments, and an enterprise account subsystem.

15. The method of claim 11, wherein the remediation event is one of an action event or a notification event to an employee received via an employee subsystem of the plurality of subsystems.

16. The method of claim 15, wherein the notification event comprises one or more likely options for remedying the failure to be performed by the employee.

17. The method of claim 16, comprising:
with the automated remediation platform, monitoring events sent from the at least one of a plurality of subsystems to the event subsystem associated the one or more likely options to determine effectiveness of remediation.

18. The method of claim 15, wherein the event subsystem comprises an automated event manager and a notification manager for receiving, respectively, the action event and the notification event, the notification manager receiving notification of the events from the plurality of subsystems.

19. The method of claim 11, comprising:
issuing the remediation event an identifier that associates monitored events and the failure with the remediation event.

20. A non-transitory computer readable medium for at least in part automating remediation in an enterprise system, the computer readable medium comprising computer executable instructions for:
receiving a request to perform an action, the action including at least one of a plurality of subsystems to be completed, the plurality of subsystems comprising employee and customer subsystems;
transmitting an event, based on the request, to the at least one of a plurality of subsystems via an event subsystem;
with an automated remediation platform:
monitoring events sent from the at least one of a plurality of subsystems to the event subsystem to detect a failure; and
in response to detecting the failure, generating a trigger event for consumption by the event subsystem; and
in response to receiving the trigger event, transmitting a remediation event for consumption by the at least one of a plurality of subsystems.
